(19) United States
(12) Patent Application Publication
(10) Pub. No.: US 2012/0302308 A1
(43) Pub. Date: Nov. 29, 2012

(54) Random Prize Using Dollar Bill Serial Number

(76) Inventor: Tyler T. Parham, Reno, NV (US)

(21) Appl. No.: 13/302,875

(22) Filed: Nov. 22, 2011

Related U.S. Application Data
(60) Provisional application No. 61/416,222, filed on Nov. 22, 2010.

(51) Int. Cl. G07F 17/32

(52) U.S. Cl. 463/17

(57) ABSTRACT

In one embodiment, a method includes determining a monetary instrument at a computing device. The monetary instrument is read to determine a first set of numbers from the monetary instrument. A second set of numbers is determined randomly. The computing device then analyzes the first set of numbers and the second set of numbers to determine if the first set of numbers for the monetary instrument qualifies a user for a prize. Then it is determined if a pre-qualification event has occurred. The user is awarded the prize if the monetary instrument qualifies the user of the prize and the pre-qualification event has occurred.

### CROSS REFERENCE TO RELATED APPLICATIONS

The present application claims priority to U.S. Provisional App. No. 61/416,222 for “RANDOM PRIZE USING DOLLAR BILL SERIAL NUMBER” filed Nov. 22, 2010, the contents of which is incorporated herein by reference in their entirety.

### BACKGROUND

Particular embodiments generally relate to gaming.

When playing a game, the user must insert money into a bill acceptor (scanner) to establish an amount of credits that are used in playing the game. For example, a $1 bill, $5 bill, $20 bill, and so on, may be inserted into the scanner and an amount of credits is provided to the user. The user then uses the credits to play the game. The user can then cash out any credits that are left when the user is finished playing the game.

### SUMMARY

In one embodiment, a method includes determining a monetary instrument at a computing device. The monetary instrument is read to determine a first set of numbers from the monetary instrument. A second set of numbers is determined randomly. The computing device then analyzes the first set of numbers and the second set of numbers to determine if the first set of numbers for the monetary instrument qualifies a user for a prize. Then it is determined if a pre-qualification event has occurred. The user is awarded the prize if the monetary instrument qualifies the user of the prize and the pre-qualification event has occurred.

In one embodiment, an apparatus includes one or more computer processors and a computer-readable storage medium comprising instructions for controlling the one or more computer processors to be operable to: determine a monetary instrument; read the monetary instrument to determine a first set of numbers from the monetary instrument; determine a second set of numbers randomly; analyze the first set of numbers and the second set of numbers to determine if the first set of numbers for the monetary instrument qualifies a user for a prize ; determine if a pre-qualification event has occurred; and award the prize to the user if the monetary instrument qualifies the user of the prize and the pre-qualification event has occurred.

In one embodiment, a non-transitory computer-readable storage medium is provided that contains instructions for controlling a computer system to be operable to: determine a monetary instrument; read the monetary instrument to determine a first set of numbers from the monetary instrument; determine a second set of numbers randomly; analyze the first set of numbers and the second set of numbers to determine if the first set of numbers for the monetary instrument qualifies a user for a prize; determine if a pre-qualification event has occurred; and award the prize to the user if the monetary instrument qualifies the user of the prize and the pre-qualification event has occurred.

The following detailed description and accompanying drawings provide a better understanding of the nature and advantages of the present invention.

### BRIEF DESCRIPTION OF THE DRAWINGS

FIG. 1A depicts an example of a machine according to one embodiment.

FIG. 1B shows a more detailed example of scanning system and logic in machine 100 according to one embodiment.

FIG. 1C shows an example of a serial number according to one embodiment.

FIG. 2 depicts an example of a method of determining a random prize using the serial number according to one embodiment.

FIG. 3 illustrates hardware of a special purpose computing machine configured with the logic of the machine according to one embodiment.

### DETAILED DESCRIPTION

Described herein are techniques for a game using a serial number of a dollar bill. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

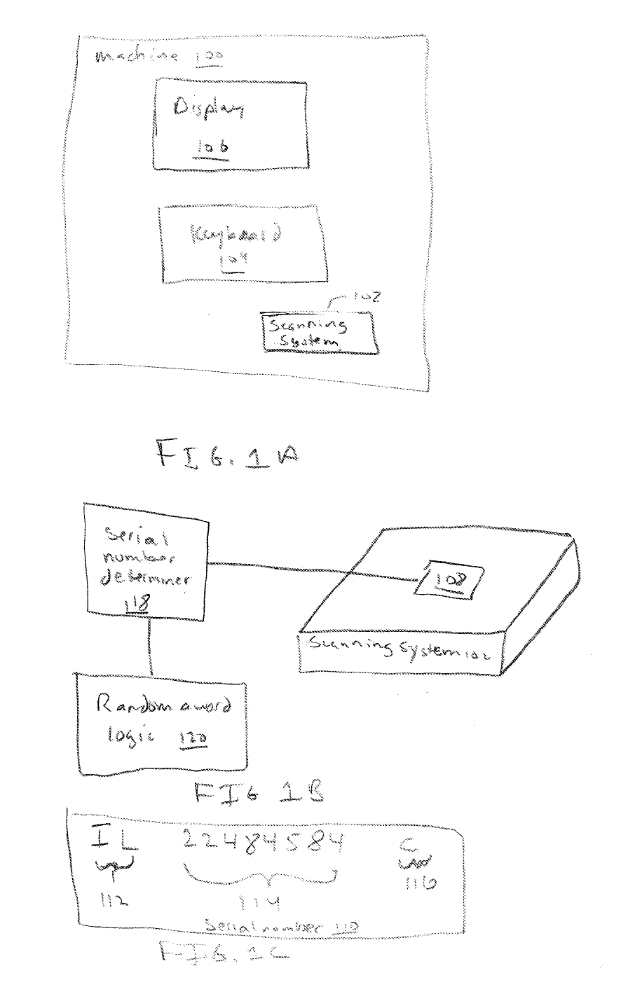

FIG. 1A depicts an example of a machine 100 according to one embodiment. Machine 100 may be a gaming machine that is offering a game of chance in a gaming establishment. Also, machine 100 may be any other machine that can receive monetary instruments, such as a vending machines, change machines, ticket dispensing machines, etc. Monetary instruments may be dollar bills, credit cards, automated teller machine cards (ATM) cards, gift cards, smart card, rewards program cards, player tracking cards, etc. Additionally, machine 100 may be dispensing monetary instruments, such as dollar bills. For example, machine 100 includes an automated teller machine (ATM) that is dispensing dollar bills.

Machine 100 includes a scanning system 102, an input device 104, and a display 106. Other components may also be appreciated. In one embodiment, input device 104 is used to interact with a game displayed on display 106. For example, a game of chance, such as video poker, slot games, keno, etc., is being played.

At some point, a monetary instrument is determined at scanning system 102. For example, scanning system 102 may be a bill acceptor that receives dollar bills. In other embodiments, other methods are used to determine the monetary instrument. For example, a user may wireless send an account number for a bank account. The monetary instrument is intended to provide a player with the opportunity bet and to play a game of chance or provide money to another entity, such as the owner of a gaming establishment or machine 100. For example, a user may be requesting $20 dollars of credit for playing a game. If the monetary instrument is a dollar bill, the denomination of the dollar bill may be any possible denomination, such as a $1 bill, $5 bill, $20 bill, and $100 bill. Also, money may be debited from a credit card or ATM card or any other means of transferring money in order to pay for a service. The insertion of the monetary instrument gives a user credits on machine 100. For example, the credits may be used to play the game. In other examples, the credits may be used to purchase an item or for receiving change. For example, the user may be purchasing a candy bar with a credit card or may be requesting change for a dollar bill.

FIG. 1B shows a more detailed example of scanning system 102 and logic in machine 100 according to one embodiment. Scanning system 102 may include a scanner 108, such as a photocell, that is used to scan the dollar bill. For example, scanner 108 may be used in verifying the authenticity and/or denomination of the dollar bill to provide credits to the user. Additionally, scanner 108 may be a stripe reader that can read information from a credit card or ATM card. Other scanning systems may include wireless receivers to receive account information or other identifying information from users. Also, any scanning system may be used such as a bill acceptor that are well known in the industry.

Particular embodiments use scanner 108 to determine the numbers from the monetary instrument. For example, the numbers of the serial number of the dollar bill are determined. The serial number may be a number printed on the dollar bill at certain positions. The serial number may be a series of 8 numbers. Additionally, the serial number may include other information, such as the Federal Reserve Bank that printed the money and also a series. Also, the numbers of a credit card may be read from the magnetic stripe of the credit card or any card associated with an account number.

FIG. 1C shows an example of a serial number 110 according to one embodiment. A prefix 112 includes 2 letters. The first letter denotes the currency series and the second letter indicates the Federal Reserve Bank at which the bill was produced. Digits 114 include 8 digits that represent the bill's sequential order within its group. A suffix 116 includes a letter that is a further sequential counter within each Reserve Bank's bills in a series. The suffix letter advances when the 8-digit number reaches 99999999.

A number determiner 118 is able to detect a number 110, which may be an identifying number for the monetary instrument. For example, number determiner 118 is configured to determine where the serial number is on the dollar bill and to recognize those numbers. In one embodiment, the entire serial number may be detected using scanner 108. Although the entire number is described, it will be understood that only portions may be detected or may be used. For example, a portion of the 8 digits may be used or detected.

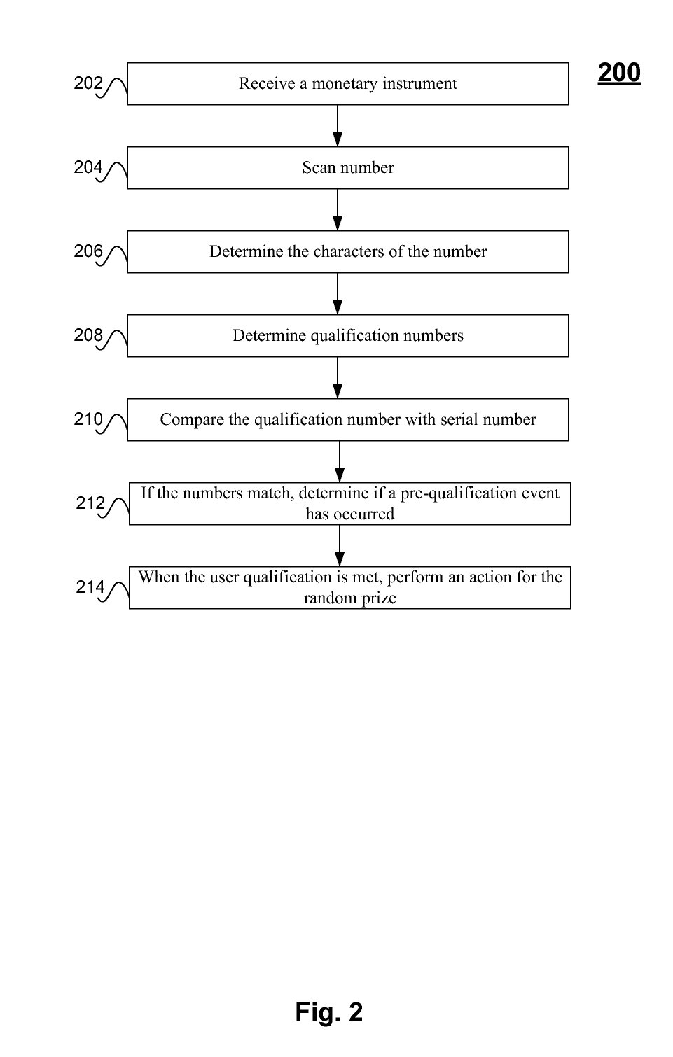

After detection, random award logic 120 may use number 110 in the random prize determination. One example of a random prize determination using serial numbers will now be described. FIG. 2 depicts an example of a method of determining a random prize using number 110 according to one embodiment. At 202, scanning system 102 receives a monetary instrument, such as a dollar bill. For example, a user may insert the dollar bill to receive credits.

At 204, number 110 is scanned. For example, scanning system 102 may capture the serial number of the dollar bill. Also, a structure separate from the scanner may also be used.

At 206, number determiner 118 determines the characters of number 110. For example, all parts of serial number 110 may be determined or a subset may be used. Also, only a portion of a credit card number may be used. For example, a user may not want an entire credit card number scanned so only the last four digits may be captured.

At 208, random prize logic determines qualification numbers. For example, qualification numbers may be randomly generated. In one example, if 8 numbers of the serial number are being used, then 8 numbers may be randomly generated.

At 210, random prize logic compares the qualification number with serial number 110. At 212, if the numbers match, determine if a predetermined user qualification event has occurred. For example, a user may have to qualify for an award. The qualification may be based on criteria, such as game play. For example, a user may have to play a certain amount of credits before receiving an award. Also, insertion of the dollar bill may be enough to qualify. Using a user qualification action prevents users from inserting monetary instruments and then cashing out immediately to insert another monetary instrument into another machine. The pre-qualification may occur before or after the match is determined. For example, the match may be determined when the dollar bill is inserted into scanning system 102. Then, after the pre-qualification event occurs, the user is notified of the prize. Also, after the pre-qualification event occurs, then it may be determined if the match occurs.

At 214, when the user qualification is met, an action for the random prize is performed. In one example, the match may be determined if all 8 numbers of the qualification number match between serial number 110 and the qualification number. In other examples, if a portion of numbers match, then the match is determined Additionally, the order of the numbers may also matter or just having the same numbers may be sufficient for a match.

The action that may be performed may vary. For example, if the match is determined, then the user may qualify for a predetermined or random prize. For example, the user may be entered into a random prize drawing that may be awarded at a later time. Also, if the match is determined, the user may win an award immediately. For example, the user may win a certain amount of credits at the game. Other prizes may also be awarded.

The random prize that is offered may depend on odds of the match. For example, if the order of 8 numbers needs to be matched, then the odds are lower that a dollar bill serial number 110 will match the qualification number. Awards may be higher in this case. If only 4 of 8 numbers match, then a lower valued prize is awarded.

In another example, when the user has qualified for a random prize, a machine among all qualified users may be randomly selected to win the random prize. If the user has qualified for an award, and the machine is randomly selected, then the random prize is awarded.

Also, a machine may be randomly selected. Then, if the user inserts a dollar bill whose serial number matches the qualification number, a prize may be awarded.

In some cases, the serial number may be recorded. When a dollar bill with the same serial number is inserted again, then this serial number may not be allowed to win again. This may prevent users from continually using the same dollar bill. However, typically, once they are inserted into scanning system 102, users cannot retrieve that bill and thus this may not be necessary. If the qualification numbers randomly change periodically, then the dollar bills used will be unique.

Another problem may exist where a user may continually cash out and retrieve other dollar bills and then scan them in again. In this case, a player's card may be required to be entered into the random prize determination. In this case, a limit on the number of entries or dollar bills scanned may be established for a player's card. This would eliminate a user continually inserting a dollar bill for credits and then immediately cashing out and inserting another dollar bill. Another means of preventing this is to qualify the bill/bill inserter only after the player has played or spent the number of credits equal to the value of the bill necessary to qualify for a prize.

In another embodiment, number 110 may be determined when a monetary instrument is dispersed. For example, as dollar bills are being dispersed to a user from an ATM, the serial numbers are read.

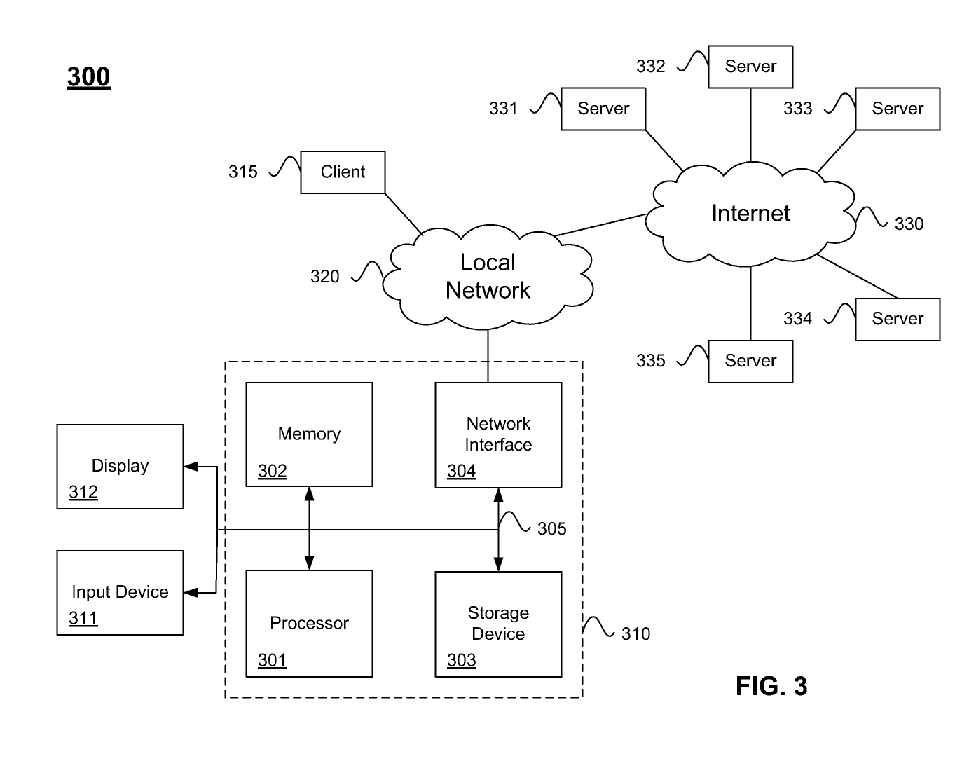

FIG. 3 illustrates hardware of a special purpose computing machine configured with the logic of machine 100 according to one embodiment. An example computer system 310 is illustrated in FIG. 3. Computer system 310 includes a bus 305 or other communication mechanism for communicating information, and a processor 301 coupled with bus 305 for processing information. Computer system 310 also includes a memory 302 coupled to bus 305 for storing information and instructions to be executed by processor 301, including information and instructions for performing the techniques described above, for example. This memory may also be used for storing variables or other intermediate information during execution of instructions to be executed by processor 301. Possible implementations of this memory may be, but are not limited to, random access memory (RAM), read only memory (ROM), or both. A storage device 303 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 303 may include source code, binary code, or software files for performing the techniques above, for example. Storage device and memory are both examples of computer readable storage mediums.

Computer system 310 may be coupled via bus 305 to a display 312, such as a cathode ray tube (CRT) or liquid crystal display (LCD), for displaying information to a computer user. An input device 311 such as a keyboard and/or mouse is coupled to bus 305 for communicating information and command selections from the user to processor 301. The combination of these components allows the user to communicate with the system. In some systems, bus 305 may be divided into multiple specialized buses.

Computer system 310 also includes a network interface 304 coupled with bus 305. Network interface 304 may provide two-way data communication between computer system 310 and the local network 320. The network interface 304 may be a digital subscriber line

(DSL) or a modem to provide data communication connection over a telephone line, for example. Another example of the network interface is a local area network (LAN) card to provide a data communication connection to a compatible LAN. Wireless links are another example. In any such implementation, network interface 304 sends and receives electrical, electromagnetic, or optical signals that carry digital data streams representing various types of information.

Computer system 310 can send and receive information through the network interface 304 across a local network 320, an Intranet, or the Internet 330. In the Internet example, software components or services may reside on multiple different computer systems 310 or servers 331-335 across the network. The processes described above may be implemented on one or more servers, for example. A server 331 may transmit actions or messages from one component, through Internet 330, local network 320, and network interface 304 to a component on computer system 310. The software components and processes described above may be implemented on any computer system and send and/or receive information across a network, for example.

Particular embodiments may be implemented in a computer-readable storage medium for use by or in connection with the instruction execution system, apparatus, system, or machine. The computer-readable storage medium contains instructions for controlling a computer system to perform a method described by particular embodiments. The instructions, when executed by one or more processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining a monetary instrument at a computing device;
reading the monetary instrument to determine a first set of numbers from the monetary instrument;
determining a second set of numbers randomly;
analyzing the first set of numbers and the second set of numbers to determine, by the computing device, if the first set of numbers for the monetary instrument qualifies a user for a prize;
determining if a pre-qualification event has occurred; and
awarding the prize to the user if the monetary instrument qualifies the user of the prize and the pre-qualification event has occurred.

2. The method of claim 1, wherein the monetary instrument is received via a scanner that optically reads the first set of numbers.

3. The method of claim 1, wherein the monetary instrument is received via a stripe reader that magnetically reads the first set of numbers.

4. The method of claim 1, wherein analyzing comprises:
comparing the second set of numbers to the first set of numbers; and
determining if the user qualifies for the prize based on the comparison.

5. The method of claim 1, wherein the monetary instrument comprises a dollar bill and the first set of numbers comprises a serial number on the dollar bill.

6. The method of claim 1, wherein the monetary instrument comprises a card and the first set of numbers comprises an identification number on the card.

7. The method of claim 1, further comprising:
recording the first set of numbers; and
not allowing a prize to be awarded when the first set of numbers is encountered during a period of time.

8. The method of claim 1, wherein determining the monetary instrument comprises receiving a dollar bill via a dollar bill acceptor at the computing device.

9. The method of claim 1, wherein determining the monetary instrument comprises distributing a dollar bill via the computing device.

10. An apparatus comprising:
one or more computer processors; and
a computer-readable storage medium comprising instructions for controlling the one or more computer processors to be operable to:
determine a monetary instrument;
read the monetary instrument to determine a first set of numbers from the monetary instrument;
determine a second set of numbers randomly;
analyze the first set of numbers and the second set of numbers to determine if the first set of numbers for the monetary instrument qualifies a user for a prize;
determine if a pre-qualification event has occurred; and
award the prize to the user if the monetary instrument qualifies the user of the prize and the pre-qualification event has occurred.

11. The apparatus of claim 10, wherein the monetary instrument is received via a scanner that optically reads the first set of numbers.

12. The apparatus of claim 10, wherein the monetary instrument is received via a stripe reader that magnetically reads the first set of numbers.

13. The apparatus of claim 10, wherein analyze comprises:
compare the second set of numbers to the first set of numbers; and
determine if the user qualifies for the prize based on the comparison.

14. The apparatus of claim 10, wherein the monetary instrument comprises a dollar bill and the first set of numbers comprises a serial number on the dollar bill.

15. The apparatus of claim 10, wherein the monetary instrument comprises a card and the first set of numbers comprises an identification number on the card.

16. The apparatus of claim 10, further operable to:
record the first set of numbers; and
not allow a prize to be awarded when the first set of numbers is encountered during a period of time.

17. The apparatus of claim 10, wherein determine the monetary instrument comprises receive a dollar bill via a dollar bill acceptor at the computing device.

18. The apparatus of claim 10, wherein determine the monetary instrument comprises distribute a dollar bill via the computing device.

19. A non-transitory computer-readable storage medium containing instructions for controlling a computer system to be operable to:
determine a monetary instrument;
read the monetary instrument to determine a first set of numbers from the monetary instrument;
determine a second set of numbers randomly;
analyze the first set of numbers and the second set of numbers to determine if the first set of numbers for the monetary instrument qualifies a user for a prize;
determine if a pre-qualification event has occurred; and
award the prize to the user if the monetary instrument qualifies the user of the prize and the pre-qualification event has occurred.

20. The apparatus of claim 19, wherein the monetary instrument is received via a scanner that optically reads the first set of numbers.
